(19) United States
(12) Patent Application Publication
(10) Pub. No.: US 2025/0073753 A1
(43) Pub. Date: Mar. 6, 2025

(54) HANGING PROCESSING DEVICE COUPLING TO MOBILE MINERAL MATERIAL PROCESSING PLANT

(71) Applicant: METSO FINLAND OY, Espoo (FI)

(72) Inventors: Tuomas Juutinen, Espoo (FI); Vesa-Matti Salminen, Espoo (FI)

(73) Assignee: METSO FINLAND OY, Espoo (FI)

(21) Appl. No.: 18/724,089

(22) PCT Filed: Nov. 29, 2022
(86) PCT No.: PCT/FI2022/050796

§ 371 Date: Jun. 25, 2024

(30) Foreign Application Priority Data
Dec. 27, 2021 (FI) 20216351

(51) Int. Cl. B07B 1/00; B07B 1/46

(52) U.S. Cl. CPC B07B 1/005; B07B 1/46; B07B 2201/04

(57) ABSTRACT

A method and apparatus for coupling a hanging processing device to a mobile platform. The processing device is supported by a moving part that is pivotably supported by a fixing part with a pivot residing closer to a bottom than top of the moving part. At a first time, the moving part is supported to a given operating angle of the processing device by an interlink that together with at least one of the moving part or the fixing part provides a plurality of effective lengths with selectable latching, until a second time. At the second time, the interlink is released using an interlink movement mechanism and pivoting the moving part with relation to the fixing part using an adjustment actuator that is functionally coupled between the mobile platform and the processing device.

### CROSS-REFERENCE TO RELATED APPLICATIONS

This application is the U.S. national stage application of International Application PCT/FI2022/050796, filed Nov. 29, 2022, which international application was published on Jul. 6, 2023, as International Publication WO 2023/126569 A1 in the English language. The International Application claims priority of Finnish Patent Application No. 20216351 filed Dec. 27, 2021.

### TECHNICAL FIELD

The present disclosure generally relates to hanging processing device coupling to mobile mineral material processing plant.

### BACKGROUND

This section illustrates useful background information without admission of any technique described herein representative of the state of the art.

Mobile mineral material processing plants typically comprise a movable platform. The movable platform may have crawler tracks, wheels, or skids. If the mobile mineral material processing plant is equipped with a crusher, the crusher is typically placed on the movable platform. A processing device such as a screen, conveyor, magnetic separator, and/or a feeder, on the other hand, may be hung in line with the platform.

An angle of the processing device can be varied by changing an angle in which the processing device hangs. In one construction, a processing device frame is pivotably attached at a lower edge to the platform. A support rod of adjustable length attaches an upper edge to the platform. By adjusting the length of the support rod, the angle of the processing device can be changed.

The adjustable support rod may be also equipped with a hydraulic piston for changing the adjustment. For run-time suspension of the processing device, the adjustable rod can be provided with a telescopic support that has two or more locking lengths.

Mobility and site efficiency both favour compact structures. A typical mobile mineral material processing plant is that compact that maintenance often requires dissembling parts such as screen decks or conveyors. The time consumed by maintenance is increased by such dissembling operations. Moreover, the dissembling also often requires heavy lifting, which may require using jacks or machines available on site, and/or several people. It is therefore desirable to improve balancing between operational capabilities and ease of maintenance.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided system for hanging processing device coupling to a mobile mineral material processing plant that comprises a mobile platform, the mobile platform comprising a main frame, the system comprising:
a fixing part comprising a lower coupling for mounting the fixing part to a respective lower coupling counterpart in the main frame;
the fixing part further comprising an upper coupling for mounting the fixing part to a respective upper counterpart of the main frame;
the fixing part further comprising an interlink connector closer to the upper coupling than to the lower coupling;
a moving part comprising N upper joints, and a lower joint; wherein N is at least one;
an interlink for connecting the moving part and the fixing part with an adjustable angle of the processing device;
the interlink comprising a fixing part connector for connecting with the interlink connector of the fixing part;
the interlink further comprising M latch counterparts; wherein M is at least one and a sum of N and M is greater than two;
the N upper joints and the M latch counterparts being complementary and configured to connect the moving part with the fixing part with a given changeable distance from the fixing part connector;
the interlink further comprising an adjustment actuator for changing said distance.

Advantageously, the system comprising separate fixing and moving parts conveniently allows adapting attachment points of different mobile platforms and moving parts for each other.

The system may further comprise an interlink movement mechanism configured to engage or disengage one of the N upper joints with one of the M latch counterparts. The interlink movement mechanism may comprise an interlink actuator. The interlink movement mechanism may comprise a wire, chain, and/or a belt for remote movement of the interlink to engage or disengage.

The system may comprise two or more interlinks. Each interlink may comprise M latch counterparts.

The moving part may comprise two or more portions forming upper joints. Each portions forming upper joints may comprise N upper joints. The portions may be laterally separated.

The system may further comprise an actuated locking system configured to lock the upper coupling to the main frame of the mobile platform. The actuated locking system may comprise a locking pin. The actuated locking system may comprise an attaching actuator configured to move the locking pin. The actuated locking system may comprise a latch configured to lock one or more upper couplings to the main frame of the mobile platform. The latch may be configured to move between a lock position and a release position. The latch may be hinged. The latch may be configured to move slidably. In the lock position the latch may lock at least one upper coupling to the main frame of the mobile platform. In the release position the latch may be disengaged from the upper coupling.

Advantageously, the system may enable coupling of a processing device without an operator approaching coupling points. Use of ladders may be avoided on coupling a processing device to a mobile platform.

The fixing part may define a fork. The fork may be downwards opening when the fixing part is mounted to the mobile platform. The lower coupling may be connected to one prong of the fork.

The fork may be configured to accommodate a portion of a first conveyor.

The processing device may comprise a screen, a conveyor, a magnetic separator, and/or a feeder. The screen may be a multideck screen.

The first conveyor may be configured to receive an oversize fraction from a top deck of the screen. The fork may be configured to accommodate a portion of a second conveyor. The first conveyor may be configured to receive an oversize fraction from a second deck of the screen. The second deck may be next to the top deck.

Advantageously, the system may enable jointly attaching and detaching a hanging screen and associated conveyors. Further advantageously, the second and second conveyors may be attached to and detached from the hanging screen and the third conveyor simply by releasing the upper and lower joints and the interlink from at least one of its ends. Hence, maintenance space can be easily arranged as needed.

The upper and lower couplings may comprise pin connectors.

The lower coupling may comprise a groove or a pin and the mobile platform may comprise a matching pin or groove such that the lower joint can be engaged by moving the platform towards the fixing part.

The moving part may comprise a processing device frame. The processing device frame may be configured to support the processing device. The processing device frame may be configured to support a third conveyor under the processing device.

The moving part may comprise feet configured to support the moving part on ground. The feet may have an extended configuration in which the feet are configured to support the moving part at desired distance and angle from the ground. The feet may have a compacted configuration in which the feet are retracted. The retracting may comprise a pivoting movement. The retracting may comprise a telescopic movement.

The lower joint may be positioned above the level of the lower coupling when the mobile part is attached to the main frame via the fixing part and the mobile mineral material processing plant is in a horizontal orientation. The lower joint may be positioned so that a straight line drawn from the upper joint through the lower joint to the bottom of the moving part is divided into an upper section and a lower section, in which the lower section has a length of at most 15% of the length of the upper section.

Advantageously, by spacing the lower joint apart of the bottom of the moving part, an increased maintenance space is reserved under the moving frame when pivoted down to rest on ground.

The interlink may comprise a U-profile that has a base and flanges extending from the base. The N upper joints and the M latch counterparts may be automatically latching. The interlink may comprise one or more aligned grooves in the flanges. The M latch counterparts may comprise the one or more aligned grooves. The N upper joints may comprise a complementary latching part configured to engage with the one or more aligned grooves.

The adjustment actuator may be accommodated by the U-profile. The adjustment actuator may be a hydraulic cylinder.

The moving part may comprise one or more interlink latching grooves. The N upper joints may comprise the one or more interlink latching grooves. The M latch counterparts may comprise a complementary latching part configured to engage with the one or more aligned grooves.

The system may further comprise a mineral material crusher, such as a jaw crusher, a cone crusher, an impact crusher, a roller crusher, or a gyratory crusher.

According to a second example aspect there is provided a mobile mineral material processing plant comprising a mobile platform and the system of the first example aspect. The mobile mineral material processing plant may further comprise a crusher. The mobile mineral material processing plant may further comprise a feeder. The mobile mineral material processing plant may further comprise a screen. The screen may be a multideck screen. The mobile mineral material processing plant may be self-propelling. The mobile mineral material processing plant may be towable.

According to a third example aspect there is provided a method for coupling a hanging processing device to a mobile mineral material processing plant that comprises a mobile platform, the mobile platform comprising a main frame, the method comprising:
angle adjustably attaching a moving part to a fixing part by attaching a lower joint of the moving part to a respective lower joint counterpart in the fixing part;
attaching an interlink by a fixing part connector to an interlink connector of the fixing part;
attaching at least one of N upper joints of the moving part to an interlink at a given changeable distance from the fixing part connector, by at least one of M latch counterparts of the interlink; wherein N is at least one, M is at least one, and a sum of N and M is greater than two; and
connecting the fixing part to the main frame by a lower coupling of the fixing part and by an upper coupling of the fixing part so that the fixing part holds the moving part in an elevated orientation for a given angle of the processing device defined by said distance.

The method may comprise attaching the lower coupling by moving the main frame against the fixing part.

The method may comprise locking the upper coupling to the main frame using an actuated locking system.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 shows a system according to an example embodiment and a portion of a mobile platform of a mineral material processing plant;

FIG. 2 shows further details of the system of FIG. 1 and a smaller portion of a mobile platform of a mineral material processing plant;

FIG. 3 shows further details of the system of FIG. 1;

FIG. 4 shows further details of the system of FIG. 1;

FIG. 5 shows further details of the system of FIG. 1;

FIG. 6 shows further details of the system of FIG. 1;

FIG. 7 shows an interlink of an example embodiment;

FIG. 8 shows the system of FIG. 1 in a first angle of a processing device;

FIG. 9 shows the system of FIG. 1 in a second angle of a processing device;

FIG. 10 shows the system of FIG. 1 in a transportation angle;

FIG. 11 shows the system of FIG. 1 in a docking configuration;

FIG. 12 shows a flow chart according to an example embodiment;

FIG. 13 shows a flow chart according to another example embodiment; and

FIG. 14 shows a mobile mineral material processing plant of an example embodiment.

### DETAILED DESCRIPTION

In the following description, like reference signs denote like elements or steps.

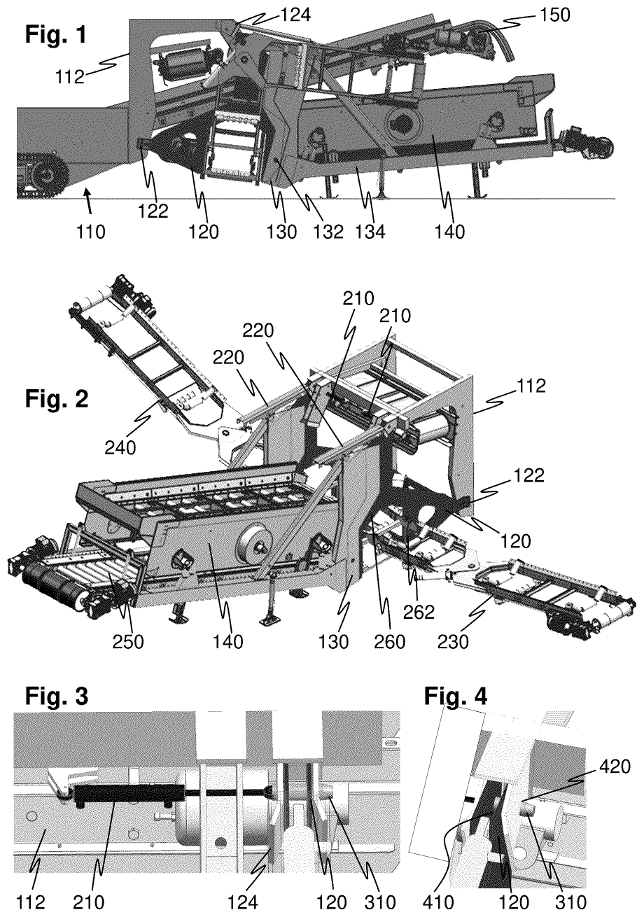

FIG. 1 shows a system according to an example embodiment and a portion of a mobile platform 110 of a mineral material processing plant 100. The mobile platform 110 comprises a main frame 112. The system comprises a fixing part 120 and a moving part 130 for supporting a processing device 140 such as a screen in a desired angle. A screen is used as an example of the processing device 140 in this detailed description. A conveyor 150 feeds mineral material onto the processing device 140.

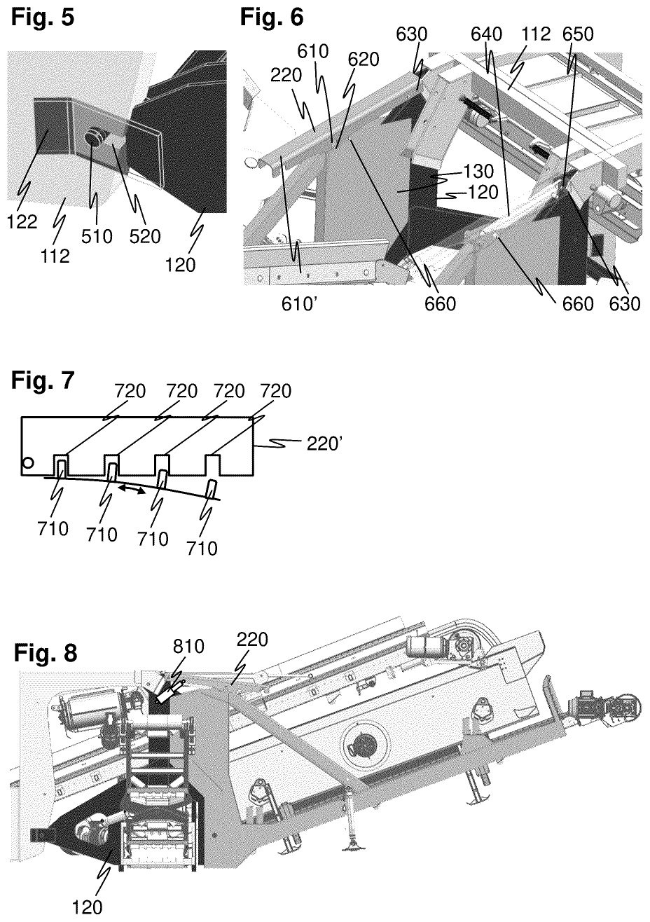

The fixing part comprises a lower coupling 122 for mounting the fixing part 120 to a respective lower coupling counterpart (FIG. 5, ref. 520) in the main frame 112. The fixing part 120 further comprises an upper coupling (FIG. 4 ref. 410) for mounting the fixing part 120 to a respective upper counterpart 124 of the main frame 112.

The moving part 130 comprises a lower joint 132 that pivotably connects the moving part 130 with the fixing part 120. The moving part 130 further comprises a screen frame 134 for supporting the screen 140.

FIG. 2 shows further details of the system of FIG. 1 and a smaller portion of the mobile platform 110 of the mineral material processing plant 100. FIG. 2 shows an interlink 220 on both sides of the moving part. FIG. 2 further shows adjustment actuators 220, a first conveyor 230, a second conveyor 240, a third conveyor 250 under the screen 140, a fork 260 formed by the fixing part and one prong 262 structurally connected the lower coupling 122. The fork 260 defines a space for partially accommodating at least one of the first conveyor 230 or the second conveyor.

As seen in FIG. 2, there are two forks 260 and only one of the second and second conveyors may be partially accommodated by each of the forks 260. In another example embodiment, at least one of the first conveyor 230 and the second conveyor 240 is partly accommodated by two forks 260.

FIG. 3 shows further details of the system of FIG. at the upper counterpart 124. An attaching actuator 210 is supported by the main frame 112 and configured to move a pin 310 into matching holes formed into the upper counterpart 124 and the fixing part 120.

FIG. 4 shows further details of the system of FIG. 1 at the upper counterpart 124. Here, the holes of the fixing part and of the upper counterpart 124 are shown with reference signs 410, 420, respectively. FIG. 4 further shows one end of the adjustment actuator (FIG. 6, ref. 640).

FIG. 5 shows further details of the system of FIG. 1 at the lower coupling 122. The main frame 112 defines a groove 520 and the lower coupling 122 in FIG. 5 comprises a matching pin 510 for abutting against an end of the groove 520 for supporting the fixing part 120 to the main frame 112 in the groove 520. In an example embodiment, the mouth of the groove 520 is formed outwards opening to facilitate entering the matching pin 510 into the groove 520.

FIG. 6 shows further details of the system of FIG. 1 for illustrating how the moving part 130 is angle adjustably supported by the fixing part 120. The interlinks 220 are formed in this embodiment to have a downwards opening U-profile that at least partly accommodates respective adjustment actuators 640. The interlinks 220 each comprise two or more latching counterparts such as grooves 610, 610′ for latching the moving part 130 at a given angle in relation to the fixing part 120 with an upper joint operating as a second latch, such as a pin 620 coupled to the moving part 130. To this end, the interlink 220 has its first pivotably connected to the fixing part 120 through a fixing part connector 630 that is here simply a pair of holes formed on the flanges of the interlink 220.

There are at least a total of three upper joints 620 and latching counterparts 610, 610′ so that using different combinations of engaging upper joints 620 and latching counterparts 610, 610′, the interlink may be locked to different lengths. In an example embodiment, at one time, only one upper joint 620 and one latching counterpart 610, 610′ are engaged. In another example embodiment two or more upper joints 620 and latching counterparts 610, 610′ can be engaged at the same time, although not necessarily in all positions.

The adjustment actuators 640 are connected at a first end thereof to the fixing part 120 using a first end locking, such as a hole formed in the first end and for receiving a pin through the fixing part connector 630 and through the interlink connector 650.

The adjustment actuators 640 are connected at a second end thereof to the moving part 130 using a second end locking 660.

FIG. 7 shows an interlink 220′ of an example embodiment, in which two or more latching counterparts 710 and upper joints 720 may simultaneously engage.

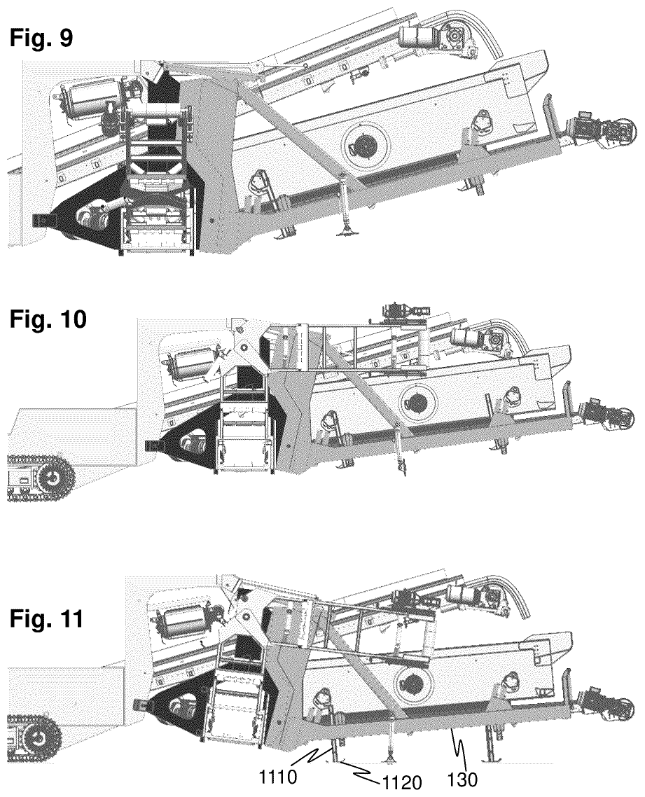

FIG. 8 shows the system of FIG. 1 in a first screening angle and FIG. 9 shows the system of FIG. 1 in a second screening angle. These different angles are maintained using different grooves of the interlinks 220. FIG. 8 also shows an interlink actuator 810 of an example embodiment for disengaging the interlink 220. The interlink actuator 810 is provided, e.g., between the fixing part 120 and the interlink 220. On adjusting the angle of the hanging screen 140, the interlink is first disengaged, then the adjustment actuator 220 moves the moving part 130 so that another set of upper joints and latching counterparts become aligned, and the interlink is engaged again. The engagement may be operated or facilitated by the interlink actuator 810. Alternatively, the engagement may occur using a gravitational force induced by the interlink 220.

FIG. 10 shows the system of FIG. 1 in a transportation angle. Here, the interlinks 220 are latched with their outmost grooves.

FIG. 11 shows the system of FIG. 1 in a docking configuration. Here, the interlinks 220 are not latched at all and the moving part rests against the ground by feet 1110 that comprise foot pads 1120. The feet 1110 are here telescopically movable for extending and compacting. The feet 1110 may be machine actuated or manually operated.

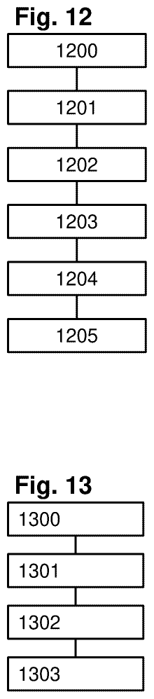

FIG. 12 shows a flow chart according to an example embodiment. FIG. 11 illustrates a method for coupling a hanging processing device to a mobile mineral material processing plant that comprises a mobile platform, the mobile platform comprising a main frame, the method comprising any one of the following steps:
angle adjustably attaching a moving part to a fixing part by attaching a lower joint of the moving part to a respective lower joint counterpart in the fixing part
attaching an interlink by a fixing part connector to an interlink connector of the fixing part
attaching at least one of N upper joints of the moving part to an interlink at a given changeable distance from the fixing part connector, by at least one of M latch counterparts of the interlink; wherein N is at least one, M is at least one, and a sum of N and M is greater than two;
connecting the fixing part to the main frame by a lower coupling of the fixing part and by an upper coupling of the fixing part so that the fixing part holds the moving part in an elevated orientation for a given angle of the processing device defined by said distance
attaching the lower coupling by moving the main frame against the fixing part
locking the upper coupling to the main frame using an actuated locking system

FIG. 13 shows a method of another example embodiment for coupling a hanging processing device to a mobile platform, comprising any one of the following steps: supporting the processing device by a moving part;
pivotably supporting the moving part to a fixing part with a pivot residing closer to a bottom than top of the moving part;
supporting at a first time the moving part to a given operating angle of the processing device by an interlink that together with at least one of the moving part or the fixing part provides a plurality of effective lengths with selectable latching, until a second time;
at the second time, releasing the interlink using an interlink movement mechanism and pivoting the moving part with relation to the fixing part using an adjustment actuator that is functionally coupled between the mobile platform and the processing device.

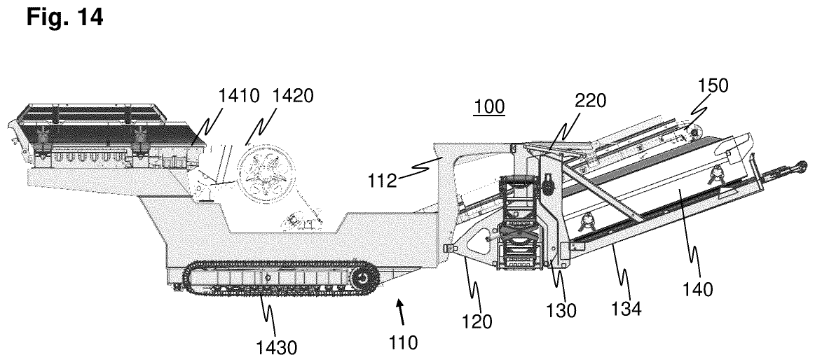

FIG. 14 shows a mobile mineral material processing plant 1400 comprising the system 100 of FIG. 1, a feeder 1410, a crusher 1420 fed by the feeder, the conveyor 150 transporting crushed mineral material from the crusher onwards onto the processing device 140, and one or more crawler tracks 1430 for moving the mobile mineral material processing plant 1400. Here, the mobile mineral material processing plant 1400 is self-propelling. In an example embodiment, the mobile mineral material processing plant 1400 is towable. The mobile mineral material processing plant 1400 may comprise one or more skids, wheels, and/or feet.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A system for hanging processing device coupling to a mobile mineral material processing plant that comprises a mobile platform, the mobile platform comprising a main frame, the system comprising:
a fixing part comprising a lower coupling for mounting the fixing part to a respective lower coupling counterpart in the main frame;
the fixing part further comprising an upper coupling for mounting the fixing part to a respective upper counterpart of the main frame;
the fixing part further comprising an interlink connector closer to the upper coupling than to the lower coupling;
a moving part comprising N upper joints and a lower joint;
an interlink for connecting the moving part and the fixing part with an adjustable angle of the processing device;
the interlink comprising a fixing part connector for connecting with the interlink connector of the fixing part;
the interlink further comprising M latch counterparts; wherein M is at least one and a sum of N and M is greater than two;
the N upper joints and the M latch counterparts being complementary and configured to connect the moving part with the fixing part with a given changeable distance from the fixing part connector;
the interlink further comprising an adjustment actuator for changing said distance.

2. The system of claim 1, further comprising an actuated locking system configured to lock the upper coupling to the main frame of the mobile platform.

3. The system of claim 2, wherein the actuated locking system comprises a locking pin and an attaching actuator configured to move the locking pin.

4. The system of claim 1, wherein the moving part comprises a processing device frame that is configured to support the processing device.

5. The system of claim 1, wherein the fixing part defines a fork that is downwards open, when the fixing part is mounted to the main frame.

6. The system of claim 5, wherein the lower coupling is connected to one prong of the fork.

7. The system of claim 5, wherein
the processing device is a multideck screen;
the fork is configured to accommodate a portion of a first conveyor that is configured to receive an oversize fraction from a top deck of the multideck screen.

8. The system of claim 7 further comprising two of the forks, wherein a first fork is configured to accommodate a portion of the first conveyor and a second fork is configured to accommodate a portion of a second conveyor that is configured to receive an oversize fraction from a second deck of the multideck screen.

9. The system of claim 1, wherein the lower coupling and the upper coupling comprise pin connectors.

10. The system of claim 1, wherein the lower coupling comprises a groove or a pin and the mobile platform comprises a matching pin or groove such that the lower joint can be engaged by moving the main frame towards the fixing part.

11. The system of claim 1, wherein
the interlink further comprises a U-profile that has a base and flanges extending from the base; and
the automatic latch comprises a groove made to the flanges.

12. The system of claim 11, wherein the adjustment actuator is accommodated by the U-profile.

13. A mobile mineral material processing plant comprising a mobile platform, and the system of claim 1.

14. The mobile mineral material processing plant of claim 13, further comprising a crusher, and/or a screen.

15. A method for coupling a hanging processing device to a mobile mineral material processing plant, comprising:
angle adjustably attaching a moving part to a fixing part by attaching a lower joint of the moving part to a respective lower joint counterpart in the fixing part;
attaching an interlink by a fixing part connector to an interlink connector of the fixing part;
attaching at least one of N upper joints of the moving part to an interlink at a given changeable distance from the fixing part connector, by at least one of M latch counterparts of the interlink; wherein N is at least one, M is at least one, and a sum of N and M is greater than two; and
connecting the fixing part to the main frame by a lower coupling of the fixing part and by an upper coupling of the fixing part so that the fixing part holds the moving part in an elevated orientation for a given angle of the processing device defined by said distance.
